(19) United States
(12) Patent Application Publication
(10) Pub. No.: US 2023/0116634 A1
(43) Pub. Date: Apr. 13, 2023

(54) NEW AGROCHEMICAL FORMULATIONS

(71) Applicant: BASF SE, Ludwigshafen (DE)

(72) Inventors: Ulrich Steinbrenner, Ludwigshafen (DE); Wolfgang Laik, Neustadt (DE); Rolf Foerster, Ludwigshafen (DE); Christine Froehlich-Rutz, Ludwigshafen (DE); Jens Bruns, Limburgerhof (DE)

(21) Appl. No.: 17/909,561

(22) PCT Filed: Feb. 25, 2021
(86) PCT No.: PCT/EP2021/054668

§ 371 Date: Sep. 6, 2022

(30) Foreign Application Priority Data
Mar. 6, 2020 (EP) 20161415.3

(51) Int. Cl. A01N 43/10; A01N 41/10; A01N 25/04

(52) U.S. Cl. CPC A01N 43/10; A01N 25/04; A01N 41/10

(57) ABSTRACT

Agrochemical formulation, said formulation being an aqueous suspoemulsion comprising an aqueous phase and an oil phase, wherein said oil phase comprises an acetamide pesticide and a solvent S1 where solvent S1 is not miscible with water, wherein said solvent S1 is a hydrocarbon or a triglyceride or a mixture thereof, and wherein said aqueous phase comprises mesotrione as suspended solid particles and an aqueous solvent S2, where S2 is water or a mixture of water with other solvents.

The present invention is directed to agrochemical formulations, said formulations being aqueous suspoemulsions comprising an aqueous phase and an oil phase, wherein said oil phase comprises an acetamide pesticide and a solvent S1 where solvent S1 is not miscible with water, wherein said solvent S1 is a hydrocarbon or a triglyceride or a mixture thereof and wherein said aqueous phase comprises mesotrione as suspended solid particles and an aqueous solvent S2, where S2 is water or a mixture of water with other solvents.

Mesotrione is an important herbicide. To achieve high biological efficiency, mesotrione is often used in combination with herbicides from the class of acetamides, such as dimethenamid-P. It is further advantageous to apply such herbicides in one formulation. Aqueous formulations are preferred for ecological reasons and easier handling.

Mesotrione is essentially insoluble in water. As it turned out, however, mesotrione is very labile against intramolecular cyclization to 6-methylsulfonyl-3,4-dihydro-2H-xanthene-1,9-dione in the presence of acetamide herbicides and water. Therefore, suspoemulsions containing these herbicides are chemically not sufficiently stable.

It was therefore the objective of the present invention to provide an aqueous formulation containing mesotrione and an acetamide herbicide, in which the mesotrione does not degrade.

WO 08/135854 discloses an oil dispersion (OD) of mesotrione containing water and acid. Other herbicides, including acetamides, may be present, however, no indication is made to the instability of mesotrione in the presence of acetamides.

The objective of the present invention was therefore to provide an aqueous liquid formulation comprising mesotrione and an acetamide herbicide that is chemically stable.

This objective has been achieved by an agrochemical formulation, said formulation being an aqueous suspoemulsion comprising an aqueous phase and an oil phase, wherein said oil phase comprises an acetamide pesticide and a solvent S1 where solvent S1 is not miscible with water, wherein said solvent S1 is a hydrocarbon or a triglyceride or a mixture thereof and wherein said aqueous phase comprises mesotrione as suspended solid particles and an aqueous solvent S2, where S2 is water or a mixture of water with other solvents.

A suspoemulsion (SE) is typically a conventional type of formulation in the field of the agrochemical formulations. In SE formulations of pesticides, the suspoemulsion is pre-formed in the commercial product and is conventionally diluted with a carrier, such as water, when making up the spray mixture.

The suspoemulsion usually comprises a continuous aqueous phase, a dispersed oil phase, and a suspended solid phase. The oil phase usually forms droplets within the aqueous phase. The oil phase usually comprises a water-immiscible solvent. The oil phase usually comprises the first pesticide, which is dissolved in the water-immiscible solvent. The solid phase usually forms solid particles within the aqueous phase. The solid phase usually comprises the second pesticide, which is suspended in a continuous aqueous phase.

Formulations according to the invention comprise mesotrione as solid particles that are dispersed in the aqueous phase. Preferably, mesotrione is not present as a chelate complex with a metal (such as Zn, Mn or Cu).

Preferably, the pH of the aqueous phase is from 1 to 5, more preferably from 2 to 4. Under these acidic conditions, mesotrione is predominantly present as the nonionic protonated compound (also referred to as the “free acid” of mesotrione). If the pH is too low or too high, higher decomposition rates of mesotrione were observed.

Mesotrione may be present in the form of crystalline or amorphous particles which are solid at 21° C. Mesotrione has a usually particle size distribution with an x50 value of from 0.1 to 10 µm, preferably 0.2 µm to 5 µm and especially preferably 0.3 µm to 2 µm or 0.5 to 1 µm. The particle size distribution can be determined by laser light diffraction of an aqueous suspension comprising the particles. The sample preparation, for example the dilution to the measuring concentration, will, in this measuring method, depend on the fineness and concentration of the active substances in the suspension sample and on the apparatus used (for example Malvern Mastersizer), inter alia. The procedure should be developed for the system in question and is known to a person skilled in the art.

Typically, formulations according to the invention contain 1 to 250 g/l of mesotrione, preferably 1 to 80 g/l and more preferably 10 to 80 g/l.

The aqueous solvent S2, contains at least 70 wt%, preferably 90 wt%, more preferably at least 95 wt% of water, based on the aqueous solvent. In one embodiment, the aqueous solvent contains up 30 wt%, preferably up to 10, more preferably up to 5 wt% or a water miscible solvent that is not miscible with the water immiscible solvent S1.

In one preferred embodiment, the aqueous S2 solvent contains only water as the solvent.

The suspoemulsion typically comprises from 20 to 85% by weight, preferably from 30 to 75% by weight and especially preferably from 35 to 70% by weight of water, based on the total weight of the suspoemulsion.

Acetamide herbicides are known to the skilled person. Preferred acetamide herbicides are diphenamid, napropheniamide, naproanilide, acetochlor, alachlor, butachlor, dimethachlor, dimethenamid, dimethenamid-P, fentrazamide, metazachlor, metolachlor, pethoxamid, propachlor, propisochlor, S-metalochlor, thenylchlor, flufenacet and mefenacet.

More preferably, said acetamide pesticide is selected from Acetochlor, Dimethenamid-P, metazachlor and S-Metolachlor.

Particularly preferably, said acetamide pesticide is selected from Acetochlor, Dimethenamid-P and S-Metolachlor.

Especially preferably, said acetamide pesticide is Dimethenamid-P.

The acetamide herbicide is at 21° C. completely dissolved in the water immiscible solvent S1.

Typically, formulations according to the invention contain 10 to 600 g/l of acetamide herbicide, preferably 50 to 500 g/l and more preferably 100 to 400 g/l.

Solvent S1 is water immiscible. This mean that it has a solubility in water of less than 1 wt%, preferably less than 0.1%, especially less than 0.001 wt%.

As it turned out, the stability of mesotrione varied depending on the nature of the water immiscible solvent. The best results were obtained with solvents having a n especially low polarity and/or a high molecular weight.

Preferred solvents S1 are hydrocarbons and triglycerides or mixtures thereof. Preferably, the solvent S1 is a hydrocarbon or a blend of a triglyceride and a hydrocarbon. Suitable triglycerides need to be liquid at 21° C.

Examples of suitable hydrocarbons include a hydrocarbon solvent such a an aliphatic, cycloaliphatic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils)). In one preferred embodiment, such hydrocarbons have been deodorized. Aromatic hydrocarbons are compounds which consist of carbon and hydrogen and which comprise aromatic groups. Preferred hydrocarbons are aliphatic and naphthenic hydrocarbons, especially aliphatic and cycloaliphatic hydrocarbons. Especially preferred hydrocarbons are aliphatic hydrocarbons.

Typical triglycerides are vegetable oils. Vegetable oils contain a high amount of triesters of glycerol with fatty acids (“triglycerides”) provided that they have not been subjected to a transesterification process with lower alcohols such as methanol. Preferred are triglycerides of C₆ -C₃₀ fatty acids, more preferred triglycerides of C₁₂-C₃₀ fatty acids. Examples of suitable vegetable oils include rapeseed oil, castor oil, corn oil, soybean oil, palm oil, sunflower oil and cottonseed oil.

Typically, solvent S1 has a high number of carbon atoms. In one embodiment, not taking into account the hydrogen atoms, the solvent contains in average more than 90 mol % carbon atoms, more preferably more than 95 mol%.

Typically, in case solvent S1 is a hydrocarbon, solvent S1 has a weight average molecular mass of 150 g/mol or above, preferably 180 g/mol or above and more preferably 200 g/mol or above. Preferred hydrocarbons are aliphatic and naphthenic hydrocarbons, especially aliphatic and cycloaliphatic hydrocarbons, particularly aliphatic hydrocarbons, in each case with a weight average molecular mass of 150 g/mol, preferably 180 g/mol or above and more preferably 200 g/mol or above.

Typically, in case solvent S1 is a vegetable oil, solvent S1 has a weight average molecular mass of 600 g/mol or above

Methyl esters of vegetable oils (transesterification products of the triglyceride containing vegetable oils) are less preferred and lead to higher degradation rates of the mesotrione. Polyethers, e.g. polypropylene oxide are also less preferred.

Solvent S1 is typically present in amounts of at least 30 wt% relative to the amount of acetamide herbicide dissolved. Preferably, solvent S1 is present between 50 and 200 wt%, more preferably between 100% and 200 wt% relative to the amount of acetamide herbicide dissolved.

The mean droplet size of the oil phase droplets is usually in the range of from 0.1 to 20 µm, in particular of from 0.3 to 10 µm and specifically of from 0.5 to 4.0 µm. The mean droplet size can be determined by particle-size measurement by means of laser diffraction, for example using a Malvern Mastersizer 2000.

Suspoemulsions according to the invention typically comprise one or more emulsifiers or surfactants in an amount to emulsify and stabilize the oil phase in the aqueous phase.

The suspoemulsion may comprise auxiliaries for agrochemical formulations. Examples for suitable auxiliaries are solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon’s, Vol.1: Emulsifiers & Detergents, McCutcheon’s Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

The suspoemulsion preferably comprises an anionic surfactant. Preferred anionic surfactants are sulfonates, where sulfonates of condensed naphthalenes are more preferred. The suspoemulsion may comprise from 0.1 to 12 wt%, preferably from 0.5 to 7 wt%, and in particular from 1 to 4 wt% of the anionic surfactant (e.g. the sulfonate).

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or al-kylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide.

Suitable adjuvants are compounds, which have a negligible or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorgan-ic clays (organically modified or unmodified), polycarboxylates, and silicates.

Suitable bactericides are bronopol and isothiazolinone derivatives such as alkylisothiazoli-nones and benzisothiazolinones.

Suitable anti-foaming agents are silicones, long chain alcohols, and salts of fatty acids. Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

The suspoemulsion may be employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating the suspoemulsion to plant propagation material, especially seeds include dressing, coating, pelleting, dusting, soaking and in-furrow application methods of the propagation material. Preferably, the suspoemulsion is applied on to the plant propagation material by a method such that germination is not induced, e. g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and other pesticides (e.g. herbicides, insecticides, fungicides, growth regulators, safeners) may be added to the suspoemulsion as premix or, if appropriate not until immediately prior to use (tank mix). These agents can be admixed with the suspoemulsion according to the invention in a weight ratio of 1:100 to 100:1, preferably 1:10 to 10:1.

Typically, tank mixes are only stored for a short period of time and are applied shortly after its preparation. Therefore, the choice of tank mix components such as additional solvents, or the pH of the tank mix are not critical with respect to the chemical stability of mesotrione.

The user applies the suspoemulsion or the tank mix prepared from the suspoemulsion usually from a pre-dosage device, a knapsack sprayer, a spray tank, a spray plane, or an irrigation system. Usually, the suspoemulsion is made up with water, buffer, and/or further auxiliaries to the desired application concentration and the ready-to-use spray liquor or the agrochemical suspoemulsion according to the invention is thus obtained. Usually, 20 to 10,000 liters, preferably 50 to 1,000 liters, of the ready-to-use spray liquor are applied per hectare of agricultural useful area.

The present invention further relates to a method of preparing the suspoemulsion by contacting solvent S2, the first pesticide, the second pesticide, the water-immiscible solvent S1, and optionally the auxiliaries. The contacting may be achieved in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Usually, the contacting is achieved by mixing (e.g. in a high shear mixer) at ambient temperatures (e.g. 10 to 40° C.).

In one preferred embodiment, suspoemulsions of the invention are prepared by first preparing a mesotrione premix by subjecting a mixture of solid mesotrione particles, water (optionally mixed with water miscible solvents that are immiscible with solvent S1), optionally surfactants and optionally further auxiliaries to milling (e.g. in a bead mill) to obtain the desired particle size. The so obtained premix is than brought into contact with water immiscible solvent S1, acetamide pesticide, optionally surfactants and is emulsified to obtain a suspoemulsion. Further auxiliaries may be added at different stages of the process.

The present invention further relates to a method of controlling undesired plant growth and/or for regulating the growth of plants, wherein the suspoemulsion is allowed to act on the respective pests, their environment or the crop plants to be protected from the respective pest, on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant’s properties. Such recombinant modifications also comprise posttranslational modifications of proteins, oligo- or polypeptides, for example by means of glycosylation or binding polymers such as, for example, prenylated, acetylated or farnesylated residues or PEG residues.

The present invention further relates to seed containing the suspoemulsion.

The advantages of the suspoemulsion according to the invention are high storage stability, even at varying or low temperatures. In particular, mesotrione shows only little degradation despite the presence of water and acetamide herbicides. Also, no phase separation or agglomeration is observed during storage. The droplet size in the suspoemulsion is small and/or stable. Moreover, the suspoemulsion according to the invention permits, if required, the addition of large amounts of fat-soluble or water-soluble adjuvants in the oil phase or the aqueous phase. The good storage stability is retained even when such substances are added.

The examples which follow illustrate the invention without imposing any limitation.

### EXPERIMENTAL PART

### Used Materials

### Mesotrione was Used as the Free Acid in Crystalline Form

Nonionic Surfactant A: block copolymer with a molar mass (from OH number) of 6500 g/mol in which the central polypropylene glycol group (molar mass of the poly-PO block 3250 g/mol) is flanked by two polyethylene glycol groups
Nonionic surfactant B nonionic polymeric surfactant with a low HLB of 6
Anionic Surfactant A Mixture of salt of Naphthalene Sulfonic Acid and Phenol Sulfonic Acid condensation product
Antifoam A silicone antifoam emulsion
Hydrocarbon Solvent A mixture of C₁₄-C₁₆ alkanes
Hydrocarbon solvent B mixture of C₁₁-C₁₄ alkanes (paraffin oil).
Solvent C water immiscible solvent, polypropyleneoxide, MW = 900 g/mol from OH number
Biocide A Mixture of Chlor-Methyl-Isothiazolinon (CIT) and Methyl-Isothiazolinon (MIT)
Biocide B Glycol based benzisothiazolinone (20%)

### Suspension Concentrate Premix A of Mesotrione Acid

75 g Mesotrione acid, 90 g 1,2-propylene glycol, 30 g Nonionic Surfactant A, 25 g Anionic Surfactant A, 5 g Antifoam A, 2 g citric acid, and 362 g water were processed in a bead mill until the volume mean average particle size reached ca. 1 µm.

### Inventive Example 1

To 15.9 g of suspension premix A was added a blend of 11.7 g Dimethenamid-P (96%), 11.7 g Hydrocarbon Solvent A and 0.9 g Nonionic surfactant B, followed by emulsification with a stirrer at 5000 rpm to form a light brown suspoemulsion. Then, 50 mg Xanthan gum, and 30 mg each Biocide A and Biocide B were added upon gentle stirring. Finally, the pH of the suspoemulsion was adjusted to pH = 3 with aqueous NaOH.

This suspoemulsion was analyzed for mesotrione, stored for 2 weeks at +54° C., re-homogenized and analyzed again. The loss of mesotrione was determined by HPLC coupled UV spectroscopy and was 5% of the initial content.

### Inventive Example 2

Like inventive example 1, but with the Hydrocarbon Solvent A having been replaced by 5.85 g triglyceride (soybean oil) and 5.85 g Hydrocarbon solvent B. Here, the loss of mesotrione was 4%.

### Reference Example 1 (Comparison)

Like inventive example 1, but Hydrocarbon Solvent A was omitted and not replaced. The loss of mesotrione was 15% of the initial content.

### Reference Example 2 (Comparison)

Like inventive example 1, but the Hydrocarbon Solvent A was replaced by Solvent C. In this case, the loss of mesotrione was 12% of the initial content.

### Reference Example 3 (Comparison)

Like inventive example 1, but the Hydrocarbon Solvent A was replaced by rape seed oil methyl ester. In this case, the loss of mesotrione was 12% of the initial content.

1. An agrochemical formulation, said formulation being an aqueous suspoemulsion comprising an aqueous phase and an oil phase, wherein said oil phase comprises an acetamide pesticide and a solvent S1, where solvent S1 is not miscible with water, and wherein said solvent S1 is a hydrocarbon or a triglyceride or a mixture thereof and wherein said aqueous phase comprises mesotrione as suspended solid particles and an aqueous solvent S2, where S2 is water or a mixture of water with other solvents and wherein said acetamide pesticide is selected from the group consisting of diphenamid, napropheniamide, naproanilide, acetochlor, alachlor, butachlor, dimethachlor, dimethenamid, dimethenamid-P, fentrazamide, metazachlor, metolachlor, pethoxamid, propachlor, propisochlor, S-metalochlor, thenylchlor, flufenacet, and mefenacet.

2. The formulation according claim 1, wherein said acetamide pesticide is selected from the group consisting of acetochlor, dimethenamid-P, metazachlor and S-metolachlor.

3. The formulation according to claim 1, wherein said acetamide pesticide is dimethenamid-P.

4. The formulation according to claim 1, wherein mesotrione is comprised in said formulation in an amount of 1 to 250 g/l.

5. The formulation according to claim 1, wherein a pH of the aqueous phase is from 1 to 5, preferably 2-4.

6. The formulation according to claim 1, wherein mesotrione is not present as a metal chelate.

7. The formulation according to claim 1, wherein said solvent S1 is comprised in said formulation in an amount of 5 to 40 wt%, based on the formulation.

8. The formulation according to claim 1, wherein said solvent S1 is a hydrocarbon or a triglyceride or a mixture thereof, said hydrocarbon being an aliphatic or cycloaliphatic hydrocarbon.

9. The formulation according to claim 1, which comprises a continuous aqueous phase, a dispersed oil phase, and a suspended solid phase.

10. A method of preparing the suspoemulsion according to claim 1, by contacting solvent S2, the first pesticide, the second pesticide, the water-immiscible solvent S1.

11. A method of controlling undesired plant growth, wherein the suspoemulsion as defined in claim 1 is allowed to act on the respective pests, their environment or the crop plants to be protected from the respective pest, on the soil and/or on undesired plants and/or on the crop plants and/or on their environment.
